(19) United States
(12) Patent Application Publication
(10) Pub. No.: US 2018/0252619 A1
(43) Pub. Date: Sep. 6, 2018

(54) ENVIRONMENTAL SAMPLING APPARATUSES, SYSTEMS, AND RELATED METHODS

(71) Applicant: Beacon Environmental Services, Inc., Forest Hill, MD (US)

(72) Inventors: Harry St. A. O'Neill, Forest Hill, MD (US); Steven C. Thornley, Dallastown, PA (US)

(21) Appl. No.: 15/451,236

(22) Filed: Mar. 6, 2017

(51) Int. Cl. G01N 1/22; B01L 3/00; G01N 1/40

(52) U.S. Cl. CPC G01N 1/2214; B01L 3/5023; B01L 2300/0832; G01N 1/405; G01N 1/2273

(57) ABSTRACT

Environmental sampling apparatuses, systems, and related methods are provided. The environmental sampling apparatus includes a vial defining an inlet having a first diameter, the vial defining an interior chamber having a second diameter larger than the first diameter. The apparatus further includes one or more adsorbent assemblies disposed within the interior chamber, the adsorbent assembly including a first and a second sampling element, each of the first and second sampling elements including a passivated mesh enclosure respectively receiving a first and a second adsorbent material, the first adsorbent material having a lower adsorbency than the second adsorbent material, and the first adsorbent material being disposed more proximate to the inlet than the second adsorbent material. The apparatus further includes a flow path extending through the inlet and along the longitudinal axis and radially inward with respect to each of the first and second adsorbent materials.

### BACKGROUND

### Field of the Disclosure

The present disclosure is directed to an environmental sampling apparatus, system, and related method.

### Description of Related Art

Determining the constituents of a particular environment is often desirable. For example, it is often desirable to detect an amount of volatile and/or semivolatile organic compounds (hereinafter referred collectively as VOCs) present in a certain environmental sample (e.g., of air, soil, etc.) Active environmental sampling is one such method of detecting VOCs and includes forcing an environmental sample into a collection medium using e.g., a pumping mechanism, over a specified period of time. Passive environmental sampling is another such method of detecting VOCs and includes exposing a collection medium (e.g., adsorbent assembly) to an environmental sample and allowing the environmental sample to infiltrate or penetrate the collection medium over a specified period of time.

However, where conventional passive environmental sampling apparatuses, systems, and/or methods are utilized, such conventional passive environmental sampling apparatuses and/or systems may have inconsistent adsorption rates of VOCs between each sampling event and not be able to target a broad range of VOCs. Additionally, such conventional passive environmental sampling apparatuses and/or systems may require disposal of the adsorbent assembly with each sampling event, which is unduly wasteful and environmentally unfriendly. Further, conventional passive environmental sampling apparatuses and/or systems do not allow for the differing adsorbents to be thermally conditioned under optimal conditions prior to assembly in an inert atmosphere and then to have the sorbent assemblies removed and analyzed separately to allow for duplicate or confirmatory analyses, or individual analyses of each sampling element.

As such, a need exists for improved environmental sampling apparatuses, systems, and related methods that provide for consistent adsorption rates of compounds, assembly of sampling apparatuses with differing adsorbents that require different temperatures and conditions for thermal conditioning, disassembly of the sampling apparatuses to allow for separate analyses of singular sampling elements or pairs of sorbent assemblies from one device, and allow for reuse of adsorbent assemblies after each sampling event.

### SUMMARY OF THE DISCLOSURE

Improved environmental sampling apparatuses, systems, and methods are disclosed. In some aspects, an environmental sampling apparatus comprises a vial extending along a longitudinal axis from a proximal end defining an inlet having a first diameter to an opposing distal end, the vial between the inlet and the distal end defining an interior chamber having a second diameter larger than the first diameter; one or more adsorbent assembly disposed within the interior chamber, the adsorbent assembly including a first sampling element and a second sampling element, each of the first and second sampling elements including a passivated mesh enclosure respectively receiving a first adsorbent material and a second adsorbent material, the first adsorbent material having a lower adsorbency than the second adsorbent material, and the first adsorbent material within the first sampling element of the adsorbent assembly being disposed more proximate to the inlet than the second adsorbent material within the second sampling element; and a flow path for interacting a gaseous substance with the adsorbent assembly within the vial, the flow path extending through the inlet and along the longitudinal axis within the interior chamber toward the distal end, the flow path thereby extending along the adsorbent assembly, and radially inward with respect to each of the first and second adsorbent materials disposed within the adsorbent assembly, so as to provide a consistent adsorption rate of compounds in the gaseous substance by the first and second adsorbent materials within the vial

In other aspects, an environmental sampling system comprises a vial extending along a longitudinal axis from a proximal end defining an inlet having a first diameter to an opposing distal end, the vial between the inlet and the distal end defining an interior chamber having a second diameter larger than the first diameter; one or more adsorbent assembly disposed within the interior chamber, the adsorbent assembly including a first sampling element and a second sampling element, each of the first and second sampling elements including a passivated mesh enclosure respectively receiving a first adsorbent material and a second adsorbent material, the first adsorbent material having a lower adsorbency than the second adsorbent material, and the first adsorbent material within the first sampling element of the adsorbent assembly being disposed more proximate to the inlet than the second adsorbent material within the second sampling element; a flow path for interacting a gaseous substance with the adsorbent assembly within the vial, the flow path extending through the inlet and along the longitudinal axis within the interior chamber toward the distal end, the flow path thereby extending along the adsorbent assembly, and radially inward with respect to each of the first and second adsorbent materials disposed within the adsorbent assembly, so as to provide a consistent adsorption rate of compounds in the gaseous substance by the first and second adsorbent materials within the vial; and an inert vial holder configured to receive the vial therein and having a suspension element, the suspension element allowing the vial to be suspended such that the inlet of the vial is disposed opposite to the suspension element.

In other aspects, a method of forming the environmental sampling system comprises inserting each of a first adsorbent material and a second adsorbent material into a respective passivated mesh enclosure to form a first sampling element and a second sampling element, the first adsorbent material having a lower adsorbency than the second adsorbent material; assembling the first sampling element and the second sampling element into an adsorbent assembly; and inserting a pair of adsorbent assemblies into a vial through an inlet thereof such that the adsorbent assemblies are disposed within an interior chamber of the vial, the vial extending along a longitudinal axis from a proximal end defining the inlet having a first diameter to an opposing distal end, the vial between the inlet and the distal end defining the interior chamber having a second diameter larger than the first diameter, and each adsorbent assembly being disposed within the interior chamber such that the first adsorbent material within the first sampling element of the adsorbent assembly is disposed more proximate to the inlet than the second adsorbent material within the second sampling element, so as to define a flow path for interacting a gaseous substance with each of the adsorbent assemblies within the vial, the flow path extending through the inlet and along the longitudinal axis within the interior chamber toward the distal end, the flow path thereby extending along each of the adsorbent assemblies, and radially inward with respect to each of the first and second adsorbent materials disposed within each of the adsorbent assemblies, so as to provide a consistent adsorption rate of compounds in the gaseous substance by the first and second adsorbent materials within the vial.

In still further aspects, a reusable environmental sampling system comprises a vial extending along a longitudinal axis from a proximal end defining an inlet having a first diameter to an opposing distal end, the vial between the inlet and the distal end defining an interior chamber having a second diameter larger than the first diameter; two adsorbent assemblies removably disposed within the interior chamber, each adsorbent assembly including a first sampling element and a second sampling element, each of the first and second sampling elements including a passivated mesh enclosure respectively receiving a first adsorbent material and a second adsorbent material, the first adsorbent material having a lower adsorbency than the second adsorbent material, and the first adsorbent material within the first sampling element of each adsorbent assembly being disposed more proximate to the inlet than the second adsorbent material within the second sampling element, each adsorbent assembly being removable from the interior chamber for analysis of the first and second adsorbent materials, and reinsertable within the interior chamber for subsequent environmental sampling; and a flow path for interacting a gaseous substance with each of the adsorbent assemblies within the vial, the flow path extending through the inlet and along the longitudinal axis within the interior chamber toward the distal end, the flow path thereby extending along each of the adsorbent assemblies, and radially inward with respect to each of the first and second adsorbent materials disposed within each of the adsorbent assemblies, so as to provide a consistent adsorption rate of compounds in the gaseous substance by the first and second adsorbent materials within the vial.

The aspects, functions and advantages discussed herein may be achieved independently in various example implementations/aspects or may be combined in yet other example implementations/aspects, further details of which may be seen with reference to the following description and drawings.

### BRIEF DESCRIPTION OF THE DRAWINGS

Having thus described the disclosure in general terms, reference will now be made to the accompanying drawings, which are not necessarily drawn to scale, and wherein:

FIG. 1A illustrates an exemplary environmental sampling apparatus in an assembled state according to some aspects of the present disclosure;

FIG. 1B illustrates the exemplary environmental sampling apparatus of FIG. 1A in a disassembled state;

FIG. 2A illustrates a first exemplary embodiment of an adsorbent assembly in a dissembled state according to some aspects of the present disclosure;

FIG. 2B illustrates the adsorbent assembly of FIG. 2A in an assembled state with a first sampling element disposed in series with a second sampling element;

FIG. 3A illustrates a second exemplary embodiment of an adsorbent assembly in a dissembled state according to some aspects of the present disclosure;

FIG. 3B illustrates the adsorbent assembly of FIG. 3A in an assembled state with a first sampling element disposed in parallel with a second sampling element;

FIG. 4 illustrates an exemplary environmental sampling system in an assembled state according to some aspects of the present disclosure;

FIG. 5 illustrates a schematic of analysis and testing of first set of sampling elements and second set of sampling elements from an environmental sampling apparatus according to some aspects of the present disclosure; and

FIG. 6 illustrates a method flow diagram of a method for forming an environmental sampling system according to some aspects of the present disclosure.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will be thorough and complete, will fully convey the scope of the disclosure to those skilled in the art, and will satisfy applicable legal requirements. Like numbers refer to like elements throughout. As used in this specification and the claims, the singular forms “a,” “an,” and “the” include plural referents unless the context clearly dictates otherwise.

As disclosed herein, environmental sampling apparatuses and/or systems are used in many different applications including, but not limited to, indoor and outdoor air monitoring, analysis of the off-gassing of soil, water, biofuels (e.g., oil and gas reservoirs), polymers, packaging materials, flavors and fragrances, cosmetics, exhaust gases, and many other applications where volatile species are present. Particular materials selected for inclusion as adsorbent materials in adsorbent assemblies of environmental sampling apparatuses and/or systems are variable depending on a particular environmental sample to be analyzed (e.g., air, soil, etc.) The terms “adsorbent assemblies”, “adsorbent materials”, and the like are used for convenience purposes only, and the adsorbent assemblies or materials described herein are effective to adsorb and desorb analyte species. In certain aspects, by selecting combinations of different materials, the environmental sampling apparatuses and/or systems are effective to passively sample environmental species (e.g., air species, soil species) including samples having a broad molecular weight range of analytes.

In some examples, the environmental sampling apparatuses and/or systems described herein are advantageously used in passive sampling methods where the environmental sample comprises ambient air that is permitted to diffuse or flow into the environmental sampling apparatuses and/or systems without the assistance of a pump or other mechanical device. Passive sampling in this manner permits the use of fewer mechanical parts, uses substantially no energy and increases the overall applicability of the environmental sampling apparatuses and/or systems described herein. In particular, for example, the environmental sampling apparatuses and/or systems described herein are usable in any setting where it is desirable to analyze species in a gas phase using diffusive monitoring. These sources may exist in industrial settings, home settings, materials testing settings, or in other settings that include one or more species that are or may be in the gas phase.

In some other examples, the environmental sampling apparatuses and/or systems described herein are used in passive sampling methods where the environmental sample comprises soil. For example, the environmental sampling apparatuses and/or systems described herein are capable of being placed in or above the soil for a desired time to permit diffusion of soil vapor into the environmental sampling apparatuses and/or systems.

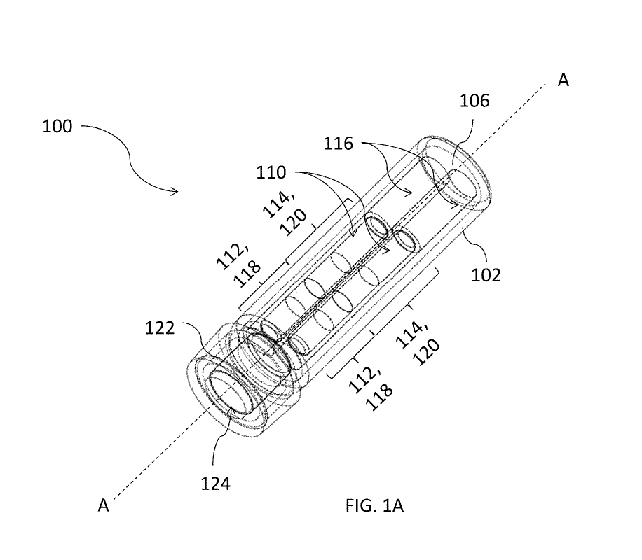

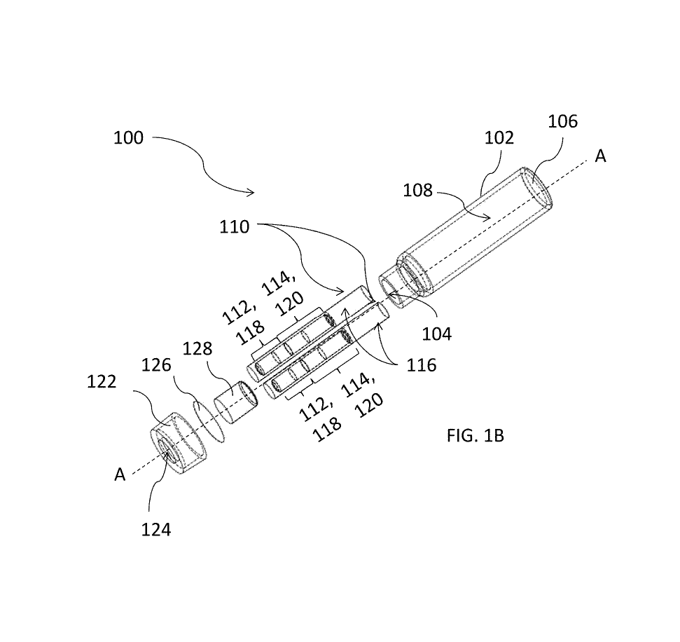

Referring now to FIGS. 1A and 1B a perspective view of an environmental sampling apparatus 100 in an assembled state and an exploded view of the environmental sampling apparatus 100 in a disassembled state are illustrated, respectively. The environmental sampling apparatus 100 is a sampling apparatus configured to provide for passive environmental sampling of including, but not limited to, air sampling, soil sampling, and the like.

In some aspects, the environmental sampling apparatus 100 comprises a vial 102 extending along a longitudinal axis A-A from a proximal end defining an inlet 104 having a first diameter to an opposing distal end 106. For example, the diameter of the inlet 104 is about 8 mm. The vial 102, in some aspects, defines between the inlet 104 and the distal end 106 an interior chamber 108 having a second diameter larger than the first diameter. For example, the second diameter of the interior chamber 108 is about 16 mm. However, other measurements of the diameters of the inlet 104 and the interior chamber 108 are also contemplated, with the first diameter being smaller than the second diameter. In other instances, the inlet 104 and/or the interior chamber 108 define a cross-section other than a cylinder such as a square, a rectangular, an oval, a triangle, etc.

In some aspects, the interior chamber 108 of the vial 102 comprises, in some instances, a length of about 60 mm, while a “neck” or the proximal end defining the inlet 104 comprises a length of about 10 mm. Thus, due to its relatively small size, the vial 102 is easily transportable and manipulatable, as well as able to be used for a sampling event without occupying excessive space. As used herein, a “sampling event” is a defined period of time during which the environmental sampling apparatus and/or system is used to obtain an environmental sample. In this manner, it is desirable that the vial 102 be formed from a material that is lightweight, a good insulator, and/or will not break during the sampling event. As such, in some aspects, the vial 102 comprises a non-crystalline amorphous solid such as an acrylic, a polycarbonate, glass, or another translucent and inert material. Accordingly, other measurements of the lengths and/or diameters of the inlet 104 and/or the interior chamber 108, as well as other materials, are also contemplated.

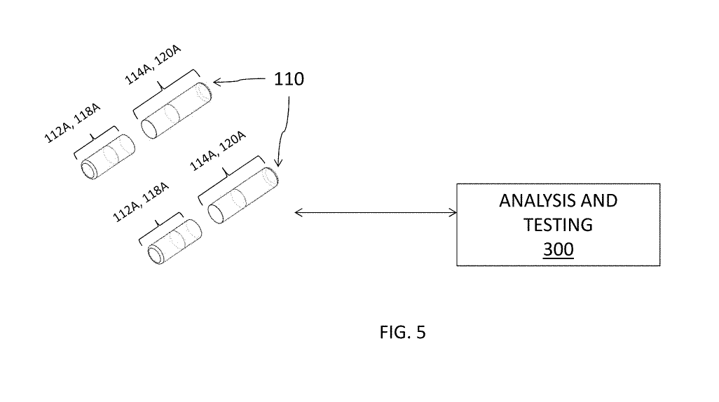

FIGS. 1A and 1B further illustrate two adsorbent assemblies 110 disposed within the interior chamber 108 (FIG. 1A) and aligned for insertion into the interior chamber 108 (FIG. 1B). One of ordinary skill in the art may note that while two adsorbent assemblies 110 are illustrated in FIGS. 1A-3B, one adsorbent assembly, two adsorbent assemblies, three adsorbent assemblies, four adsorbent assemblies, etc., are contemplated for use with the environmental sampling apparatus 100 and/or system (e.g., system 200, FIG. 4) disclosed herein.

Each of the two adsorbent assemblies 110 include, in some aspects, a first sampling element 112 and a second sampling element 114, each including a passivated mesh enclosure. Further, in some aspects, each adsorbent assembly 110 includes a mesh cylinder 116 configured to receive one of the first sampling elements 112 and one of the second sampling elements 114 therein. Accordingly, as illustrated in FIGS. 1A, 1B, a single interior chamber 108 is configured to receive two adsorbent assemblies 110, each adsorbent assembly 110 including the first sampling element 112 and the second sampling element 114.

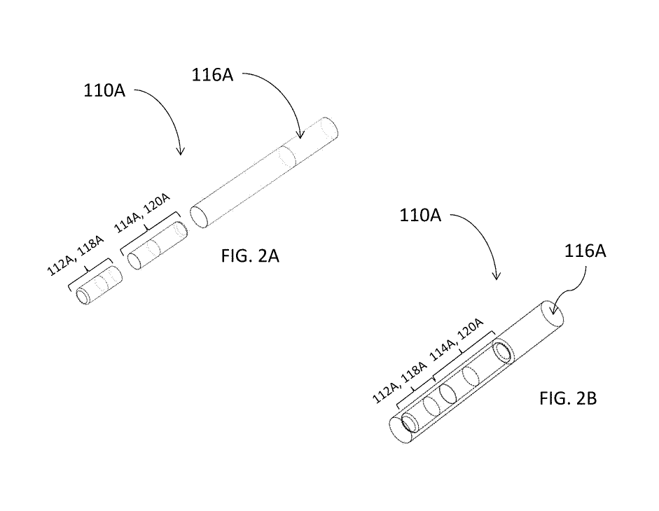

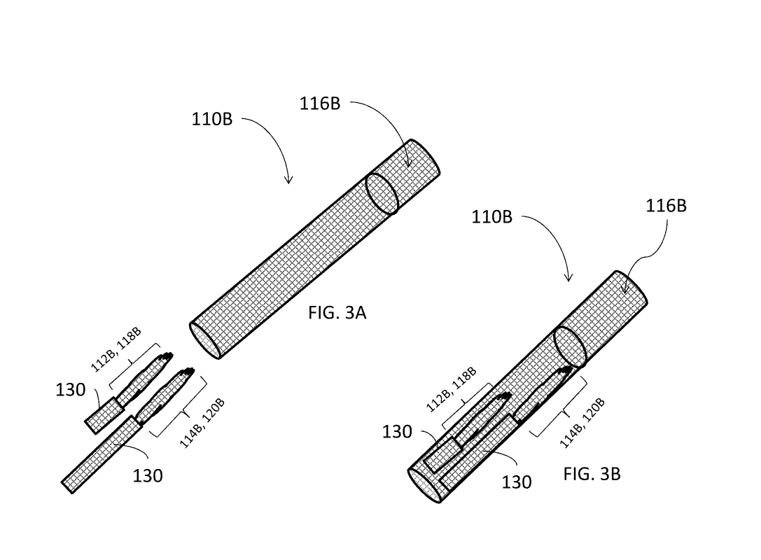

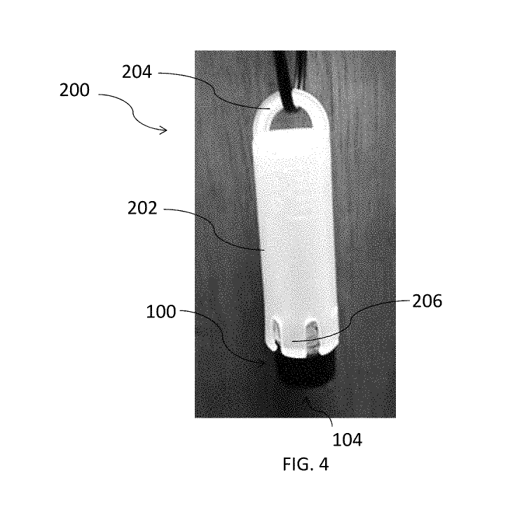

Within each of the adsorbent assemblies 110, a first adsorbent material 118 and a second adsorbent material 120 are respectively received within the passivated mesh enclosure of the first sampling element 112 and the second sampling element 114. For example, the passivated mesh enclosure is configured to individually and substantially contain or enclose a respective one of the first adsorbent material 118 and the second adsorbent material 120. In these instances, the passivated mesh enclosure is a mesh cylinder (see, e.g., FIGS. 2A-2B), a mesh pouch (see, e.g., FIGS. 3A-3B), and the like, formed of, for example, a 100 mesh SAE 304 grade stainless steel, quartz, or other metal or non-metal based material that is passivated by way of an inert passive coating applied thereto prior to forming an enclosure for receipt of the first adsorbent material 118 or the second adsorbent material 120. For example, the inert passive coating is a chemical vapor deposition process that applies a thin, inert coating to the material mesh enclosure.

In some aspects, prior to the first and second sampling elements 112, 114 being inserted into the mesh cylinder 116, the first and second sampling elements 112, 114 of each adsorbent assembly 110 are thermally conditioned under optimal conditions (e.g., in an inert gas atmosphere so as to be devoid of VOCs of interest and other compounds that would be adsorbed on the sampling elements) such that the first and the second adsorbent materials 118, 120 have the “target compounds” or other VOCs removed therefrom prior to the sampling elements 112, 114 being inserted into the mesh cylinder 116 and/or these adsorbent assemblies 110 being received within the vial 102. More particularly, thermal conditioning comprises heating the individual types of adsorbent materials in the inert gas atmosphere (e.g., laboratory grade nitrogen or helium).

The passivated mesh enclosure, in some aspect, differs in size for each of the first sampling element 112 and the second sampling element 114. For example, the passivated mesh enclosure for the first sampling element 112 is about 12 mm in length and has an inner diameter of about 4.6 mm. An interior chamber of the mesh enclosure of the first sampling element 112 for receiving the first adsorbent material 118 is about 5 mm in length. In another example, the passivated mesh enclosure for the second sampling element 114 is about 17 mm in length and has an inner diameter of about 4.6 mm. An interior chamber of the mesh enclosure of the second sampling element 114 for receiving the second adsorbent material 120 is about 4.6 mm in length. An outer diameter of one or both of the mesh enclosures of the first sampling element 112 and the second sampling element 114 is about 6.4 mm. However, the measurements of the sampling elements 112, 114 are variable depending on the size and/or shape of the vial 102 and/or the properties and/or required amount of the adsorbent material 118, 120.

The mesh cylinder 116 of each adsorbent assembly 110 comprises a substantially elongated cylinder that is sized to receive the first sampling element 112 and the second sampling element 114 therein. For example, the mesh cylinder is about 30 mm in length and has a diameter of about 6.4 mm. In some aspects, more than one first sampling element 112 and/or second sampling element 114 are received within the mesh cylinder 116. For example, in one aspect, two first sampling elements 112 and three second sampling elements 114 are received within the mesh cylinder 116, although this is variable depending on the size and/or shapes of the mesh cylinder 116. The mesh cylinder 116 is also configured to receive additional sampling elements, such as a third sampling element, a fourth sampling element, etc., depending on a length and/or diameter of the mesh cylinder 116. Similar to the passivated mesh enclosure, in some aspects, for example, the mesh cylinder 116 is configured to be an inert, porous material such as a 100 mesh SAE 304 grade stainless steel, quartz, or other metal or non-metal based material that, in some instances, is passivated by way of an inert passive coating applied thereto. In this way, the mesh cylinder 116 is devoid of target compounds and allows for effective adsorption of the gaseous substance by the adsorbent materials enclosed within the mesh cylinder 116.

Referring to FIGS. 2A, 2B, a first embodiment of a single adsorbent assembly 110A such as that illustrated in FIGS. 1A, 1B is provided. The adsorbent assembly 110A comprises a first sampling element 112A and a second sampling element 114A enclosed by a mesh cylinder 116A. Each of the first and second sampling elements 112A, 114A includes a passivated mesh enclosure formed as a mesh cylinder respectively receiving a first adsorbent material 118A and a second adsorbent material 120A, the first adsorbent material 118A having a lower adsorbency than the second adsorbent material 120A. As illustrated in FIGS. 2A, 2B, with the mesh cylinder 116A, the first sampling element 112A is disposed in series or “in line” with the second sampling element 114A, with the first adsorbent material 118A within the first sampling element 112A being disposed more proximate to an inlet (e.g., inlet 104, FIGS. 1A, 1B) than the second adsorbent material 120A within the second sampling element 114A. In some aspects, not illustrated in FIGS. 2A, 2B, there is no mesh cylinder, such that the first sampling element 112A is disposed in series or “in line” with the second sampling element 114A directly within the vial 102A, with the first adsorbent material 118A within the first sampling element 112A being disposed more proximate to an inlet (e.g., inlet 104, FIGS. 1A, 1B) than the second adsorbent material 120A within the second sampling element 114A.

Referring now to FIGS. 3A, 3B, a second embodiment of a single adsorbent assembly 110B such as that illustrated in FIGS. 1A, 1B is provided. The adsorbent assembly 110B comprises a first sampling element 112B and a second sampling element 114B enclosed by a mesh cylinder 116B or directly inserted within a vial 102B. Each of the first and second sampling elements 112B, 114B includes a passivated mesh enclosure formed as a mesh pouch respectively receiving a first adsorbent material 118B and a second adsorbent material 120B, the first adsorbent material 118B having a lower adsorbency than the second adsorbent material 120B. As illustrated in FIGS. 3A, 3B, with the mesh cylinder 116B or the vial 102, the first sampling element 112B is disposed in parallel with the second sampling element 114B, with the first adsorbent material 118B within the first sampling element 112B being disposed more proximate to an inlet (e.g., inlet 104, FIGS. 1A, 1B) than the second adsorbent material 120B within the second sampling element 114B. In some aspects, not illustrated in FIGS. 3A, 3B, there is no mesh cylinder, such that the first sampling element 112B is disposed in parallel with the second sampling element 114B directly within the vial 102B, with the first adsorbent material 118B within the first sampling element 112B being disposed more proximate to an inlet (e.g., inlet 104, FIGS. 1A, 1B) than the second adsorbent material 120B within the second sampling element 114B.

In some aspects, and still referring to FIGS. 3A, 3B, the passivated mesh enclosure (e.g., the mesh pouch) of each of the first and second sampling elements 112B, 114B includes a position-adjustment member 130. For example, the mesh pouch illustrated in the adsorbent assembly 110B comprises the position-adjustment member 130 formed as a tab engaged therewith. The tab, in this aspect, is different lengths for each of the first sampling element 112B and the second sampling element 114B. In other examples, the position-adjustment member 130 is engaged with mesh enclosures formed as cylinders or other suitable enclosure configurations. Regardless, the position-adjustment member 130 is configured to extend within the mesh cylinder 116B, between the respective passivated mesh enclosure to which it is engaged and the inlet of the vial (e.g., vial 102, FIGS. 1A, 1B). In some aspects, the position-adjustment member 130 is adjustable in length so as to adjust a disposition of each passivated mesh enclosure relative to the inlet. In some aspects, since the first adsorbent material 118B within the first sampling element 112B is disposed more proximate to an inlet (e.g., inlet 104, FIGS. 1A, 1B) than the second adsorbent material 120B within the second sampling element 114B, the first sampling element 112B does not require a position-adjustment member 130.

In some aspects, the position-adjustment member 130 is formed as a tab, as shown in FIGS. 3A, 3B, or is otherwise formed as a spring, arm, bellows, etc., that expands or contracts to increase or decrease in length. Where the position-adjustment member 130 is engaged with the mesh enclosure, the position-adjustment member 130 is configured to be selectively increased or decreased in length in order to adjust a position of the mesh pouch enclosing the first sampling element 112B to be relatively shorter, and a position of the mesh pouch enclosing the second sampling element 114B to be relatively longer, with respect to the inlet 104 of the vial 102, when the first and second sampling elements 112B, 114B are disposed within the mesh cylinder 116B in the interior chamber 108. In some aspects, not illustrated in FIGS. 3A, 3B, there is no mesh cylinder, such that the position-adjustment member 130 is engaged with a mesh enclosure of a first and second sampling element introduced directly into a vial (e.g., vial 102, FIGS. 1A, 1B). Also, in some aspects, since the first adsorbent material 118B within the first sampling element 112B is disposed more proximate to an inlet (e.g., inlet 104, FIGS. 1A, 1B) than the second adsorbent material 120B within the second sampling element 114B, the first sampling element 112B does not require a position-adjustment member 130.

Referring back to FIGS. 1A, 1B, in some aspects, the first adsorbent material 118 and the second adsorbent material 120 are two different materials of different adsorbencies. For example, the first adsorbent material 118 and the second adsorbent material 120 include or are a mixture of graphitized carbon blacks of different adsorbent strengths, graphite, carbon molecular sieves, polymer resins, oxides, fused silica beads, glass, quartz, charcoal, porous polymers, amisorbs or other materials. In certain aspects, the different adsorbent materials have a different chemical composition, e.g., each includes or is a different carbon black. In some examples, the adsorbent materials are a derivatized form, e.g., a derivatized carbon black. As such, in aspects of the present disclosure, it is desirable for the first adsorbent material 118 to have a lower adsorbency than an adsorbency of the second adsorbent material 120. For example, the first adsorbent material 118 comprises a porous polymer having an adsorbency of about 50 m²/gram, and the second adsorbent material 120 comprises a carbon molecular sieve having an adsorbency of about 500 m²/gram. Otherwise, in other aspects, the first adsorbent material 118 has a higher adsorbency than an adsorbency of the second adsorbent material 120 or the two adsorbent materials 118, 120 have a similar or substantially similar adsorbency.

Where the first adsorbent material 118 has a lower adsorbency than an adsorbency of the second adsorbent material 120, the first adsorbent material 118 within the first sampling element 112 of each adsorbent assembly 110 is disposed more proximate to the inlet 104 than the second adsorbent material 120 within the second sampling element 114. Such a disposition is desirable as it provides the ability for the environmental sampling apparatus 100 to adsorb many different types of species during a single sampling event, while providing a consistent or substantially consistent uptake rate of those adsorbed species along the length of the interior chamber 108. The term “lower adsorbency” is a relative term referring to adsorption strength and efficiency, which is a function of surface area, pore size(s) and shape(s), pore volume, and/or surface chemistry of the adsorbent material. No absolute adsorption strength is required, rather the various materials that are used are stronger or weaker adsorbers relative to another material. It will be within the ability of the person of ordinary skill in the art, given the benefit of this disclosure, to select a material that is stronger or weaker in adsorbency than another material. Higher boiling point VOCs (compounds) are typically retained by the weaker sorbent materials, and the lighter analytes break through and are retained by the stronger sorbent materials. Thus, in some aspects, when compounds are adsorbed in the adsorbent materials, the high boiling point materials are adsorbed in the first adsorbent materials 118 disposed more proximate to the inlet 104, and the low boiling point materials are adsorbed in the second adsorbent materials 120 disposed less proximate to the inlet 104 (i.e., closer to the distal end 106).

Accordingly, in some aspects, a flow path for passively interacting a gaseous substance (e.g., environmental sample) with each of the adsorbent assemblies 110 within the vial 102 is provided. More particularly, for example, the flow path extends through the inlet 104 and along the longitudinal axis A-A within the interior chamber 108 toward the distal end 106, such that the flow path extends longitudinally along each of the adsorbent assemblies 110. Thus, when the adsorbent assemblies 110 are inserted into the interior chamber 108 of the vial 102, the flow path is defined thereby. In addition, for example, the flow path is also defined radially inward with respect to each of the first and second adsorbent materials 118, 120 disposed within each of the adsorbent assemblies 110. Such a configuration and arrangement provides a consistent adsorption rate (i.e., uptake rate) of compounds in the gaseous substance by and along the length of the first and second adsorbent materials 118, 120, as well as radially inward with respect to the first and second adsorbent materials 118, 120, within the vial 102. In this manner, the environmental sampling apparatus 100 enables axial-radial flow for substantially 360 degree adsorption of species within the gaseous substance by each of the first and second adsorbent materials 118, 120. As a result, the environmental sampling apparatus 100 provides for a more controlled, consistent, and predictable uptake rate for analysis and reporting of concentration of compounds (i.e., species in the gaseous sample), for example, in parts per billion by volume (ppbv), micrograms per cubic meters (ug/m³), etc.

In some aspects, a cap 122 is provided with the apparatus 100 and is configured to be removably engaged with the proximal end of the vial 102. The cap 122, in some aspects, replaces a solid cap (not shown) that is used during shipment and storage to prevent entry of gases into the environmental sampling apparatus 100. The cap 122 has, for example, a porous portion in communication with the inlet 104 of the vial 102 so as to allow the gaseous substance to flow therethrough and into the interior chamber 108 through the inlet 104 while retaining the adsorbent assemblies 110 within the vial 102. As illustrated in FIG. 1A, the cap is engaged with the proximal end of the vial 102 by a threaded engagement on both the cap 122 and the proximal end of the vial 102, a threaded cap, snap-fit engagement, a removable solvent engagement (e.g., a glue), or the like. Otherwise, the cap 122 is permanently engaged with the apparatus 100 so that the cap 122 is not removable therefrom.

The porous portion of the cap 122 is configured to extend across an opening 124 defined by the cap. For example, the opening 124 defined by the cap comprises a diameter that is smaller or larger in diameter than that of the first diameter of the inlet 104. In this manner, the porous portion extending across the opening 124 is configured to be proportional in size to a flow of the gaseous substance into the interior chamber 108 of the vial 102, and is variable in diameter to increase or decrease the flow of the gaseous substance into the vial 102. Specifically, for example, a relatively smaller diameter opening 124 results in a relatively restricted flow of the gaseous substance, while a relatively larger diameter opening 124 results in relatively increased flow of the gaseous substance.

To reduce debris or any unwanted particulates from entering the interior chamber 108 of the vial 102, the porous portion of the cap 122 comprises, in some aspects, a porous membrane 126 extending across the opening 124 defined by the cap 122. The porous membrane 126 is variable in size depending on a diameter of the opening 124. In some instances, the porous membrane 126 comprises 100 mesh SAE 304 grade stainless steel, quartz, or other metal or non-metal based material that, in some aspects, is passivated by way of an inert passive coating applied thereto.

The apparatus 100 further comprises, in some aspects, a porous retaining member 128 that is removably engaged with the inlet 104 within the vial 102. In this way, the retaining member 128 is configured to retain the adsorbent assemblies 110 within the interior chamber 108 while allowing the gaseous substance to flow therethrough into the interior chamber 108. More particularly, the porous retaining member 128 is inserted or otherwise arranged within the inlet 104 (i.e., in a friction fit) such that the inlet 104 is substantially covered by the porous retaining member 128. Similar to the porous membrane 126, the porous retaining member 128 is variable in size depending on the first diameter of the inlet 104. For example, where the first diameter of the inlet 104 is about 8 mm, an inner diameter of the porous retaining member 128 is about 8 mm. In some aspects, the porous retaining member 128 is cylindrically shaped having a longitudinally-extending base and a lateral surface, wherein the base extends along the inlet 104 and the lateral surface extends across the inlet 104 at an interface between the inlet 104 and the interior chamber 108. In other aspects (not shown), the porous retaining member 128 is a disk that fits within the inlet 104. In some instances, the porous retaining member 128 comprises 100 mesh SAE 304 grade stainless steel, quartz, or other metal or non-metal based material that, in some aspects, is passivated by way of an inert passive coating applied thereto.

Referring now to FIG. 4, an environmental sampling system 200 is illustrated. The environmental sampling system 200 comprises, in some aspects, an environmental sampling apparatus 100 such as that described above in reference to FIGS. 1A, 1B. The environmental sampling system 200 comprises, in some aspects, in addition to the environmental sampling apparatus 100, an inert vial holder 202 configured to removably receive the vial 102 therein. For example, the inert vial holder 202 is configured with a diameter large enough to snugly receive and retain the vial 102 therein in order to enable environmental sampling over a period of time (i.e., to allow ingress of a gaseous substance into the inlet of the vial). The inert vial holder 202 is, in some aspects, comprised of a polymer, thin metal, or other flexible material that is able to receive and retain the vial 102. Otherwise, in other aspects, the inert vial holder 202 includes a mechanism configured to securely retain the vial 102 within the inert vial holder 202 upon insertion of the vial 102. For example, in one aspect, the inert vial holder 202 comprises or defines a series of flexible retaining tabs 206 about an opening defined by the vial holder 202. The retaining tabs 206, in some instances, include a flange configured to engage the interface between the portion of the vial 102 defining the inlet 104 and the portion of the vial 102 defining the interior chamber 108, when the environmental sampling apparatus 100 is inserted into the vial holder 202.

In some aspects, the vial 102 has a suspension element 204 allowing the vial 102 to be suspended such that the inlet 104 of the vial is disposed opposite to the suspension element 204. For example, the suspension element 204 comprises a loop, hook, tab or the like, attached to or integral with the vial holder 202. The suspension element 204 is engaged with a string or other suitable tether that is able to be attached to a secured and/or stabilized suspension point to allow the vial 102 to be positioned for controlled and predictable adsorption of the gaseous substance (i.e., the vial 102 is suspended such that the inlet 104 is below the interior chamber 108). Otherwise, the inert vial holder 202 is configured to be advanced, with the vial 102 received therein, into the ground or other surface in order to acquire environmental samples from soil.

In some aspects, the environmental sampling system 200 is a reusable environmental sampling system including an apparatus similar to that described above in reference to FIGS. 1A, 1B or FIGS. 3A, 3B. For example, the reusable environmental sampling system comprises a vial 102 extending along a longitudinal axis A-A from a proximal end defining an inlet 104 having a first diameter to an opposing distal end 106, the vial 102 between the inlet 104 and the distal end 106 defining an interior chamber 108 having a second diameter larger than the first diameter. The reusable environmental sampling system also comprises, in these instances, two adsorbent assemblies 110 removably disposed within the interior chamber 108, with each adsorbent assembly 110 including a first sampling element 112 and a second sampling element 114, each of the first and second sampling elements 112, 114 including a passivated mesh enclosure respectively receiving a first adsorbent material 118 and a second adsorbent material 120, with the first adsorbent material 118 having a lower adsorbency than the second adsorbent material 120, and with the first adsorbent material 118 within the first sampling element 112 of each adsorbent assembly 110 being disposed more proximate to the inlet 104 than the second adsorbent material 120 within the second sampling element 114. In such aspects, each adsorbent assembly 110 is removable from the interior chamber 108 for analysis of the first and second adsorbent materials 118, 120, and reinsertable within the interior chamber 108 for subsequent environmental sampling. The reusable environmental sampling system further comprises, in such instances, a flow path for interacting a gaseous substance with each of the adsorbent assemblies 110 within the vial 102, the flow path extending through the inlet 104 and along the longitudinal axis A-A within the interior chamber 108 toward the distal end 106, the flow path thereby extending along each of the adsorbent assemblies 110, and radially inward with respect to each of the first and second adsorbent materials 118, 120 disposed within each of the adsorbent assemblies 110, so as to provide a consistent adsorption rate of compounds in the gaseous substance by the first and second adsorbent materials 118, 120 within the vial 102.

In this manner, a mesh cylinder 116 of a first or a second adsorbent assembly 110, wherein each mesh cylinder 116 is configured to receive one of the first sampling elements 112 and one of the second sampling elements 114, is removable from the vial 102 after a sampling event for analysis. Accordingly, in some aspects, the first sampling element 112 and the second sampling element 114 of the first adsorbent assembly 110 are used for primary testing and analysis, while the first sampling element 112 and the second sampling element 114 of the second adsorbent assembly 110 are used for confirmatory or duplicate analyses of the analyses of the first sampling element 112 and the second sampling element 114 of the first adsorbent assembly 110. In other aspects, the first sampling element and the second sampling element 112, 114 of each of the adsorbent assemblies 110 are subjected to different tests to confirm or detect different compounds.

More particularly, and referring now to FIG. 5, the removal of the first sampling element 112 and/or the second sampling element 114 from the vial 102 includes, in some aspects, subjecting the removed adsorbent materials 118, 120 in the first sampling element 112 and/or the second sampling element 114, respectively, to thermal desorption or solvent extraction of the compounds (VOCs) therein. In such instances, the first and/or second adsorbent materials 118, 120 are heated in a thermal desorption instrument with a flow of inert gas, such as helium, nitrogen, or hydrogen being used to then sweep the heated VOCs out of the first and/or second adsorbent materials 118, 120 for analysis and/or testing. Alternatively, for example, a solvent is used to extract the organic compounds from the adsorbents and an aliquot of this solvent extract is injected into analytical instrument for analysis and testing.

The heated and extracted or solvent-extracted compounds are then introduceable into an analytical system 300 for identification and quantification of the compounds adsorbed. For example, identification and quantification of the compounds includes introduction of the compounds in a gas flow into a chromatographic analysis, with a compound identification instrument such as mass spectrometer, flame ionization detector (FID), photoionization detector (PID), electron capture detector (ECD), or like detector. Other methods for analyzing or detecting compounds within the environmental sample collected by the environmental sampling apparatuses and/or systems described herein are also contemplated, such methods being determined based on the type of environmental species being sampled and/or the compounds being detected. Accordingly, determination and/or detection of the compounds adsorbed by the adsorbent materials 118, 120 during a sampling event in a particular environment is desirable for procuring a representative understanding of that particular environment's composition for environmental protection and healthy safety purposes.

Subsequently, after the testing and analysis of the first sampling element 112 and the second sampling element 114 of the adsorbent assemblies 110, or after subjecting the first and second sampling elements 112, 114 of the adsorbent assemblies to thermal desorption of other suitable compound removal process, the first sampling element 112 and the second sampling element 114 are prepared for reuse in the environmental sampling apparatus and/or system described herein. In some aspects, reuse of the sampling elements involves the first and second sampling elements (e.g., 112, 114, FIGS. 1A, 1B) of each adsorbent assembly being thermally re-conditioned under optimal conditions such that the adsorbent materials have VOCs removed therefrom prior to the sampling elements being re-inserted within the vial 102. In this manner, the first sampling element 112 and the second sampling element 114 of the adsorbent assemblies 110 are ready for reinsertion within the interior chamber 108 for subsequent environmental sampling.

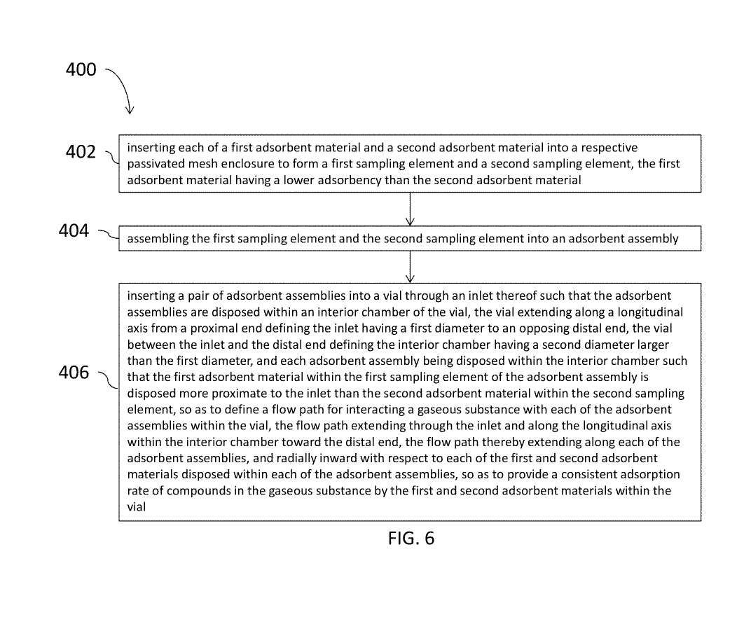

Reference is now being made to FIG. 6, which illustrates a method flow diagram, generally designated 400, of a method of forming an environmental sampling system. The environmental sampling system described in reference to method 400 includes, for example, the system 200 described herein.

In step 402, a first adsorbent material and a second adsorbent material are inserted into a respective passivated mesh enclosure to form a first sampling element and a second sampling element, the first adsorbent material having a lower adsorbency than the second adsorbent material.

In step 404, the first sampling element and the second sampling element are assembled into an adsorbent assembly.

In step 406, a pair of adsorbent assemblies are inserted into a vial through an inlet thereof such that the adsorbent assemblies are disposed within an interior chamber of the vial, the vial extending along a longitudinal axis from a proximal end defining the inlet having a first diameter to an opposing distal end, the vial between the inlet and the distal end defining the interior chamber having a second diameter larger than the first diameter, and each adsorbent assembly being disposed within the interior chamber such that the first adsorbent material within the first sampling element of the adsorbent assembly is disposed more proximate to the inlet than the second adsorbent material within the second sampling element, so as to define a flow path for interacting a gaseous substance with each of the adsorbent assemblies within the vial, the flow path extending through the inlet and along the longitudinal axis within the interior chamber toward the distal end, the flow path thereby extending along each of the adsorbent assemblies, and radially inward with respect to each of the first and second adsorbent materials disposed within each of the adsorbent assemblies, so as to provide a consistent adsorption rate of compounds in the gaseous substance by the first and second adsorbent materials within the vial.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that equivalents, modifications, and other aspects are intended to be included within the scope of the appended claims. Although specific terms are employed herein, they are used in a generic and descriptive sense only and not for purposes of limitation.

That which is claimed:

1. An environmental sampling apparatus comprising:
a vial extending along a longitudinal axis from a proximal end defining an inlet having a first diameter to an opposing distal end, the vial between the inlet and the distal end defining an interior chamber having a second diameter larger than the first diameter;
one or more adsorbent assembly disposed within the interior chamber, the adsorbent assembly including a first sampling element and a second sampling element, each of the first and second sampling elements including a passivated mesh enclosure respectively receiving a first adsorbent material and a second adsorbent material, the first adsorbent material having a lower adsorbency than the second adsorbent material, and the first adsorbent material within the first sampling element of the adsorbent assembly being disposed more proximate to the inlet than the second adsorbent material within the second sampling element; and
a flow path for interacting a gaseous substance with the adsorbent assembly within the vial, the flow path extending through the inlet and along the longitudinal axis within the interior chamber toward the distal end, the flow path thereby extending along the adsorbent assembly, and radially inward with respect to each of the first and second adsorbent materials disposed within the adsorbent assembly, so as to provide a consistent adsorption rate of compounds in the gaseous substance by the first and second adsorbent materials within the vial.

2. The apparatus of claim 1, wherein the one or more adsorbent assemblies comprises two adsorbent assemblies disposed within the interior chamber, each of the adsorbent assemblies including the first sampling element and the second sampling element.

3. The apparatus of claim 2, wherein each adsorbent assembly includes a mesh cylinder configured to receive one of the first sampling elements and one of the second sampling elements.

4. The apparatus of claim 3, wherein each of the mesh cylinders is passivated.

5. The apparatus of claim 4, wherein the mesh enclosures and the mesh cylinders are each passivated by way of an inert passive coating applied thereto.

6. The apparatus of claim 3, wherein, within each mesh cylinder, the first sampling element is disposed in series with the second sampling element, with the first adsorbent material within the first sampling element being disposed more proximate to the inlet than the second adsorbent material within the second sampling element.

7. The apparatus of claim 3, wherein, within each mesh cylinder, the first sampling element is disposed in parallel with the second sampling element, with the first adsorbent material within the first sampling element being disposed more proximate to the inlet than the second adsorbent material within the second sampling element.

8. The apparatus of claim 7, wherein the passivated mesh enclosure of each of the first and second sampling elements includes a position-adjustment member engaged therewith and extending between the respective passivated mesh enclosure and the inlet, the position-adjustment member being adjustable in length so as to adjust a disposition of each passivated mesh enclosure relative to the inlet.

9. The apparatus of claim 1, comprising a cap configured to be removably engaged with the proximal end of the vial, the cap having a porous portion in communication with the inlet so as to allow the gaseous substance to flow therethrough and into the interior chamber through the inlet while retaining the adsorbent assembly within the vial.

10. The apparatus of claim 9, wherein the porous portion of the cap comprises a porous membrane extending across an opening defined by the cap.

11. The apparatus of claim 9, wherein the porous portion is configured to be proportional in size to a flow of the gaseous substance into the interior chamber.

12. The apparatus of claim 1, comprising a porous retaining member removably engaged with the inlet, the retaining member being configured to retain the adsorbent assembly within the interior chamber while allowing the gaseous substance to flow therethrough into the interior chamber.

13. The apparatus of claim 1, wherein the first and the second adsorbent materials of the first and second sampling elements of the adsorbent assembly are thermally conditioned in an inert gas to substantially remove target compounds and other VOCs prior to being received within the vial.

14. An environmental sampling system comprising:
a vial extending along a longitudinal axis from a proximal end defining an inlet having a first diameter to an opposing distal end, the vial between the inlet and the distal end defining an interior chamber having a second diameter larger than the first diameter;
one or more adsorbent assembly disposed within the interior chamber, the adsorbent assembly including a first sampling element and a second sampling element, each of the first and second sampling elements including a passivated mesh enclosure respectively receiving a first adsorbent material and a second adsorbent material, the first adsorbent material having a lower adsorbency than the second adsorbent material, and the first adsorbent material within the first sampling element of the adsorbent assembly being disposed more proximate to the inlet than the second adsorbent material within the second sampling element;
a flow path for interacting a gaseous substance with the adsorbent assembly within the vial, the flow path extending through the inlet and along the longitudinal axis within the interior chamber toward the distal end, the flow path thereby extending along the adsorbent assembly, and radially inward with respect to each of the first and second adsorbent materials disposed within the adsorbent assembly, so as to provide a consistent adsorption rate of compounds in the gaseous substance by the first and second adsorbent materials within the vial; and
an inert vial holder configured to receive the vial therein and having a suspension element, the suspension element allowing the vial to be suspended such that the inlet of the vial is disposed opposite to the suspension element.

15. The system of claim 14, wherein the one or more adsorbent assemblies comprises two adsorbent assemblies disposed within the interior chamber, each of the adsorbent assemblies including the first sampling element and the second sampling element.

16. The system of claim 15, wherein each adsorbent assembly includes a mesh cylinder configured to receive one of the first sampling elements and one of the second sampling elements.

17. The system of claim 16, wherein each of the mesh cylinders is passivated.

18. The system of claim 17, wherein the mesh enclosures and the mesh cylinders are each passivated by way of an inert passive coating applied thereto.

19. The system of claim 16, wherein, within each mesh cylinder, the first sampling element is disposed in series with the second sampling element, with the first adsorbent material within the first sampling element being disposed more proximate to the inlet than the second adsorbent material within the second sampling element.

20. The system of claim 16, wherein, within each mesh cylinder, the first sampling element is disposed in parallel with the second sampling element, with the first adsorbent material within the first sampling element being disposed more proximate to the inlet than the second adsorbent material within the second sampling element.

21. The system of claim 20, wherein the passivated mesh enclosure of each of the first and second sampling elements includes a position-adjustment member engaged therewith and extending between the respective passivated mesh enclosure and the inlet, the position-adjustment member being adjustable in length so as to adjust a disposition of each passivated mesh enclosure relative to the inlet.

22. The system of claim 14, comprising a cap configured to be removably engaged with the proximal end of the vial, the cap having a porous portion in communication with the inlet so as to allow the gaseous substance to flow therethrough and into the interior chamber through the inlet while retaining the adsorbent assembly within the vial.

23. The system of claim 22, wherein the porous portion of the cap comprises a porous membrane extending across an opening defined by the cap.

24. The system of claim 22, wherein the porous portion is configured to be proportional in size to a flow of the gaseous substance into the interior chamber.

25. The system of claim 14, comprising a porous retaining member removably engaged with the inlet, the retaining member being configured to retain the adsorbent assembly within the interior chamber while allowing the gaseous substance to flow therethrough into the interior chamber.

26. The system of claim 14, wherein the first and the second adsorbent materials of the first and second sampling elements of the adsorbent assembly are thermally conditioned in an inert gas to substantially remove target compounds and other VOCs prior to being received within the vial.

27. A method of forming an environmental sampling system comprising:
inserting each of a first adsorbent material and a second adsorbent material into a respective passivated mesh enclosure to form a first sampling element and a second sampling element, the first adsorbent material having a lower adsorbency than the second adsorbent material;
assembling the first sampling element and the second sampling element into an adsorbent assembly; and
inserting a pair of adsorbent assemblies into a vial through an inlet thereof such that the adsorbent assemblies are disposed within an interior chamber of the vial, the vial extending along a longitudinal axis from a proximal end defining the inlet having a first diameter to an opposing distal end, the vial between the inlet and the distal end defining the interior chamber having a second diameter larger than the first diameter, and each adsorbent assembly being disposed within the interior chamber such that the first adsorbent material within the first sampling element of the adsorbent assembly is disposed more proximate to the inlet than the second adsorbent material within the second sampling element, so as to define a flow path for interacting a gaseous substance with each of the adsorbent assemblies within the vial, the flow path extending through the inlet and along the longitudinal axis within the interior chamber toward the distal end, the flow path thereby extending along each of the adsorbent assemblies, and radially inward with respect to each of the first and second adsorbent materials disposed within each of the adsorbent assemblies, so as to provide a consistent adsorption rate of compounds in the gaseous substance by the first and second adsorbent materials within the vial.

28. The method of claim 27, comprising removably engaging a cap having a porous portion in communication with the inlet with the proximal end of the vial so as to allow the gaseous substance to flow therethrough and into the interior chamber through the inlet while retaining the adsorbent assemblies within the vial.

29. The method of claim 28, wherein removably engaging the cap having the porous portion comprises removably engaging the cap having a porous membrane extending across an opening defined by the cap with the proximal end of the vial.

30. The method of claim 28, wherein removably engaging the cap having the porous portion comprises removably engaging the cap having the porous portion proportional in size to a flow of the gaseous substance into the interior chamber with the proximal end of the vial.

31. The method of claim 27, comprising removably engaging a porous retaining member with the inlet, the retaining member being configured to retain the adsorbent assemblies within the interior chamber while allowing the gaseous substance to flow therethrough into the interior chamber.

32. The method of claim 27, wherein assembling the first sampling element and the second sampling element into the adsorbent assembly comprises receiving one of the first sampling elements and one of the second sampling elements in a mesh cylinder.

33. The method of claim 32, wherein receiving one of the first sampling elements and one of the second sampling elements comprises receiving one of the first sampling elements and one of the second sampling elements in a mesh cylinder.

34. The method of claim 33, comprising applying an inert passive coating to each of the mesh enclosure and the mesh cylinder to passivate each of the mesh enclosure and the mesh cylinder.

35. The method of claim 32, comprising disposing, within each mesh cylinder, the first sampling element in series with the second sampling element, with the first adsorbent material within the first sampling element being disposed more proximate to the inlet than the second adsorbent material within the second sampling element.

36. The method of claim 32, comprising disposing, within each mesh cylinder, the first sampling element in parallel with the second sampling element, with the first adsorbent material within the first sampling element being disposed more proximate to the inlet than the second adsorbent material within the second sampling element.

37. The method of claim 36, comprising adjusting a disposition of each passivated mesh enclosure relative to the inlet via adjusting a length of a position-adjustment member engaged with the passivated mesh enclosure of each of the first and second sampling elements and extending between the respective passivated mesh enclosure and the inlet.

38. The method of claim 27, comprising thermally conditioning the first and the second adsorbent materials of the first and second sampling elements of each adsorbent assembly in an inert gas prior to the first and second sampling elements being received within the vial to substantially remove target compounds and other VOCs therefrom.

39. The method of claim 27, comprising inserting the vial into an inert vial holder configured to receive the vial therein, the vial holder having a suspension element configured to allow the vial to be suspended such that the inlet of the vial is disposed opposite to the suspension element.

40. The method of claim 27, comprising analyzing the first sampling element and the second sampling element of the second adsorbent assembly for confirmatory or duplicate analyses of analyses of the first sampling element and the second sampling element of the first adsorbent assembly.

41. A reusable environmental sampling system comprising:
a vial extending along a longitudinal axis from a proximal end defining an inlet having a first diameter to an opposing distal end, the vial between the inlet and the distal end defining an interior chamber having a second diameter larger than the first diameter;
two adsorbent assemblies removably disposed within the interior chamber, each adsorbent assembly including a first sampling element and a second sampling element, each of the first and second sampling elements including a passivated mesh enclosure respectively receiving a first adsorbent material and a second adsorbent material, the first adsorbent material having a lower adsorbency than the second adsorbent material, and the first adsorbent material within the first sampling element of each adsorbent assembly being disposed more proximate to the inlet than the second adsorbent material within the second sampling element, each adsorbent assembly being removable from the interior chamber for analysis of the first and second adsorbent materials, and reinsertable within the interior chamber for subsequent environmental sampling; and
a flow path for interacting a gaseous substance with each of the adsorbent assemblies within the vial, the flow path extending through the inlet and along the longitudinal axis within the interior chamber toward the distal end, the flow path thereby extending along each of the adsorbent assemblies, and radially inward with respect to each of the first and second adsorbent materials disposed within each of the adsorbent assemblies, so as to provide a consistent adsorption rate of compounds in the gaseous substance by the first and second adsorbent materials within the vial.

42. The system of claim 41, comprising an inert vial holder configured to receive the vial therein and having a suspension element, the suspension element allowing the vial to be suspended such that the inlet of the vial is disposed opposite to the suspension element.

43. The system of claim 41, wherein the first sampling element and the second sampling element of the second adsorbent assembly is used for confirmatory or duplicate analyses of analyses of the first sampling element and the second sampling element of the first adsorbent assembly.

44. The system of claim 41, comprising a cap configured to be removably engaged with the proximal end of the vial, the cap having a porous portion in communication with the inlet so as to allow the gaseous substance to flow therethrough and into the interior chamber through the inlet while retaining the adsorbent assemblies within the vial.

45. The system of claim 41, comprising a porous retaining member removably engaged with the inlet, the retaining member being configured to retain the adsorbent assemblies within the interior chamber while allowing the gaseous substance to flow therethrough into the interior chamber.

46. The system of claim 41, wherein each adsorbent assembly includes a mesh cylinder configured to receive one of the first sampling elements and one of the second sampling elements.

47. The system of claim 46, wherein each of the mesh cylinders is passivated.

48. The system of claim 47, wherein the mesh enclosures and the mesh cylinders are each passivated by way of an inert passive coating applied thereto.

49. The system of claim 46, wherein, within each mesh cylinder, the first sampling element is disposed in series with the second sampling element, with the first adsorbent material within the first sampling element being disposed more proximate to the inlet than the second adsorbent material within the second sampling element.

50. The system of claim 46, wherein, within each mesh cylinder, the first sampling element is disposed in parallel with the second sampling element, with the first adsorbent material within the first sampling element being disposed more proximate to the inlet than the second adsorbent material within the second sampling element.

51. The system of claim 50, wherein the passivated mesh enclosure of each of the first and second sampling elements includes a position-adjustment member engaged therewith and extending between the respective passivated mesh enclosure and the inlet, the position-adjustment member being adjustable in length so as to adjust a disposition of each passivated mesh enclosure relative to the inlet.

52. The system of claim 41, wherein the first and the second adsorbent materials of the first and second sampling elements of each adsorbent assembly are thermally conditioned in an inert gas to substantially remove target compounds prior to being received within the vial.
